(19) United States
(12) Patent Application Publication
(10) Pub. No.: US 2007/0138339 A1
(43) Pub. Date: Jun. 21, 2007

(54) Motion assisting apparatus for flying objects

(76) Inventor: Peter Logan Sinclair, London (GB)

Correspondence Address: Anthony R Barkume, 20 Gateway Lane, Manorville, NY, 11949, US

(21) Appl. No.: 10/561,379

(22) PCT Filed: Jun. 18, 2004
(86) PCT No.: PCT/GB04/02632

§ 371 Date: Oct. 21, 2006

(30) Foreign Application Priority Data
Jun. 18, 2003 (GB) 0314119.9
Dec. 3, 2003 (GB) 0328073.2

(51) Int. Cl. B64C 33/02

(52) U.S. Cl. 244/72

(57) ABSTRACT

A apparatus for assisting in flying, walking or swimming having wings, legs or fins attached to a drive mechanism in which the end of the wings, legs or fins are simultaneously oscillated and moved linearly generating lift or walk and swim movement.

The present invention relates to a motion assist apparatus for moving or propelling objects e.g. through the air, more particularly it relates to an apparatus for assisting objects to take off vertically and fly.

Fixed wing aircraft are examples of objects which have mechanisms arranged to enable the object to controllably lift-off from the ground by utilising a runway to generate lift through forward momentum and to fly.

Helicopters are examples which incorporate mechanisms arranged to enable objects to lift off vertically from the ground and fly by utilising rotating wings.

This invention is an example of a mechanism arranged to enable the object to controllably lift off vertically from the ground and fly utilising at least two wings e.g. one or two pairs of flapping wings for both lift and directional control. The opposite wings can flap in unison and adjacent wings can flap in sequence.

A prime requirement of mechanisms or apparatus for assisting objects to fly is a low weight in relation to its power output. This is to enable there to be sufficient lift to enable the object to take off from the ground.

Apart from increasing the power to weight ratio, increased lift can be obtained by increasing the efficiency of the lifting mechanism. In objects with wings which generate lift by forward movement, wing design and configuration are clearly important and in helicopters rotor design and size etc. are critical.

Flying insects generate lift by movement of their wings which have evolved into highly efficient and effective systems for flying. In some such systems a wing comprises a flexible membrane which changes shape and configuration as it is moved by the insect so the insect is maneuverable and can fly up and down and in any direction. Such systems are difficult to replicate in man made objects and previous attempts have included complex operating systems. The more complex the system the heavier it tends to be thus requiring more power etc.

A system is described in WO 03/004122.

We have now devised an apparatus for assisting in flying which reduces these problems.

According to the invention there is provided an apparatus for assisting in flying which incorporates a rotational drive mechanism, which drive mechanism comprises (i) a support member attached to a flexible wing at a first mounting point on the wing (ii) a drive means able to impart a linear oscillation to the support member and (iii) a second mounting point on the wing attached to the drive means spaced apart from the support member whereby, when the drive mechanism operates the support member moves linearly and the wing flexes due to the relative motion of the support and the second mounting point to produce angular wing movement.

Preferably the drive member is an offset cam mounted on a back plate at an angle to the back plate with the support member attached to a cam follower and the second mounting point attached to the back plate.

Preferably the cam is adjustable so that the cam angle can be adjusted during motion.

Preferably there is a drive shaft connected to the axle of the drive member through a universal joint, the drive shaft and the axle of the drive member being at an angle to each other, there being a rotor connecting member mounted on the drive shaft which is connected to the drive member at one location.

The first mounting point is preferably adjacent to the leading edge of the wing and the second mounting is nearer the trailing edge of the wing. In use the drive mechanism is configured so that, as the rotor rotates, the leading edge of the wing stays substantially at the front of the wing.

Preferably the wing is articulated e.g. the leading edge of the wing articulates separately from the rest of the wing or the wing articulates in three sections.

Preferably the support means is a rod or strut which is pivotally attached along the wing.

The back part of the wing is also pivotally mounted along its length to the wing shaft And the trailing edge of the back part of the wing pivots e.g. up to 20 degrees (relative to the front part of the wing) around the wing shaft, and back again, while the wing shaft oscillates backwards and forwards on each full wing stroke.

One way of achieving this is to connect an articulating member to the trailing edge of the back part of the wing, parallel to the wing shaft. A second member is pivotally connected to the free end of the first member and then connected to the back plate.

A circular offset cam is mounted to the main drive shaft; a half round (amplifier) cam is mounted to the member connected to the back plate, facing inwards and making edge contact with the offset cam.

As the central cam rotates, it pushes and pulls the half cam thus causing the arm and wing to move backwards and forwards around the wing shaft.

A second way utilises the differential movement between the cam follower member and a portion of the back-plate. As the offset cam rotates, it causes the middle part of the cam follower member to rise and fall relative to the back plate.

When the gap is opened to its widest point, the middle has a much larger gap than where the ends meet. The gap closes in a scissor like manner from the corner to middle. this is exploited by utilising the back end of the cam follower member and the edge of the side of the back plate as twin guide rails. (The faces that meet).

A small bus is mounted to a rail via bearings, on the underside of the cam follower arm, and the side of the said portion of the back plate. The rail runs the full length around the cam follower member and the said portion of the side of the back plate. The buses are free to move along the rail from end to end. The buses are then pivotally hinged where one edge of one bus joins the other edge of the opposite bus.

This would mean that when the gap is at its widest, the bus components would be pulled closest to the pivot point. However as the gap closes, the bus component is squeezed by the scissor action of the opposing components and is pushed down and around the guide rails until it reaches its lowest point, before once again the guide rails open up and pull the bus component back to the start position.

The trailing edge of the back part of the wing is pivotally and slidably connected to the bus that is connected to the back of the cam follower member.

This configuration allows the wing to attack the air on two planes, on both the up stroke and down stroke respectively.

This is achieved by a linear oscillation along the wing spar, produced by the rise and fall of the offset cam, connected to the cam follower, and an angular motion on the trailing edge of the back part of the wing produced by the incidental scissor type movement exploited by the bus components. As the wing is flexible this enables the wing to generate lift.

The power source can be any motor which provides a rotary motion to the drive shaft and a flying device will incorporate at least two of the devices of the present invention mounted opposite each other which can be operated by the same power source.

In an embodiment of the invention the motor, offset cam, and cam follower components are replaced by a linear motor, one end of the linear motor being connected to the back-plate, the other end connected directly to the cam follower member in the same position as the cam follower mount.

The linear motor will oscillate producing a linear oscillation on the wing spar as the offset cam did.

The scissor motion produced by the back plate and the cam follower member, utilised for angular wing movement is unaffected.

In an embodiment of the invention the wing is oscillated simultaneously about an axis and the axis is moved linearly back and forth. The combination of these two movements can give a flexing of the wing to produce lift. By tuning the amplitude and the frequency of these two movements the wing can be made to move so that only positive lift is generated and substantially no negative lift is generated at any stage. A complete cycle of the wing will thus generate lift as the wing moves downwards and on the return stroke the wing is angled so that no negative lift is generated.

Conveniently the wing can be attached to a sleeve or collar mounted on the axle so that the oscillating motion is imparted by movement of the sleeve over the axle and the axle is moved linearly to generate the linear motion.

There is preferably a common drive shaft which operates both movements.

In operation there are two wings driven by the same power source so that they flap together and in one way to control the direction of flight one wing is dipped and the other raised e.g. by a twisting movement of a control rod connected to the wing and so the wing turns in the direction of the dipped wing as in a banked turn. The control rod can also be moved from side to side and back and forth so the wings are moved sideways analogous to a turn using a rudder in a conventional fixed wing aircraft.

The amount of lift generated will depend on the speed of rotation and the area of the wings and will be dependent on the strength of the materials, particularly the wings. A flying device will be able to vertically fly forwards, backwards, turn in mid air, and land. The mechanism is able to reproduce a defined wing-beat pattern of over twenty beats per second.

The size and shape of wings used with the wing mechanisms has a direct bearing on the wing speed. If sufficient speed is achieved, a pair of wings having an A2 size surface area may be used to lift a man from the ground. The wing membrane can comprise any lightweight flexible material such as a plastics material such as polythene, the material simply being glued in place, trimmed, and the ends folded around wing frame portions, e.g. made from carbon fibre rods. Alternatively the wing can be made of a thin lightweight metal such as titanium

The drive assembly can be made from light and strong materials, such as a composite material. The flying device, including drive assembly, can be made as small as an insect, such as a wasp, or large enough to lift a man from the ground. The drive assembly could be driven by a motor or a glow plug engine with extended drive shafts acting as wing shafts, and so eliminating the need for a gear assembly.

An adjustable and deflected angle of rotation can be provided by adding a universal joint on each wing shaft, between the motor/engine and the wing mechanism. This would allow the wing mechanism to be fixed in position, and operated above, below, or to the rear of a central point of rotation. The wing mechanism could be arranged to mimic the movement of any flying insect, from a Damseifly to a Goliath Beetle, or a Humming Bird.

It is a feature of the present invention that it can enable a device to take off from a standing start, hover, fly backwards, forwards, and sideways, and turn on a five pence piece.

Any drive mechanism can be used and the apparatus can be driven by any means e.g. a motor, engine, linear motor, or possibly even pedal power.

The mechanism of the present invention can be use for propulsion through any fluid e.g. through air as well as water.

The mechanism of the invention can also be adapted for the purpose of manipulating a multi articulating leg mechanism capable of emulating an insect walking gate in which case the support member is attached to a first part of the leg mechanism and the second mounting point attached to a second part of the articulating leg so that a walking motion is imparted to the leg.

The invention is illustrated in the accompanying drawings in which

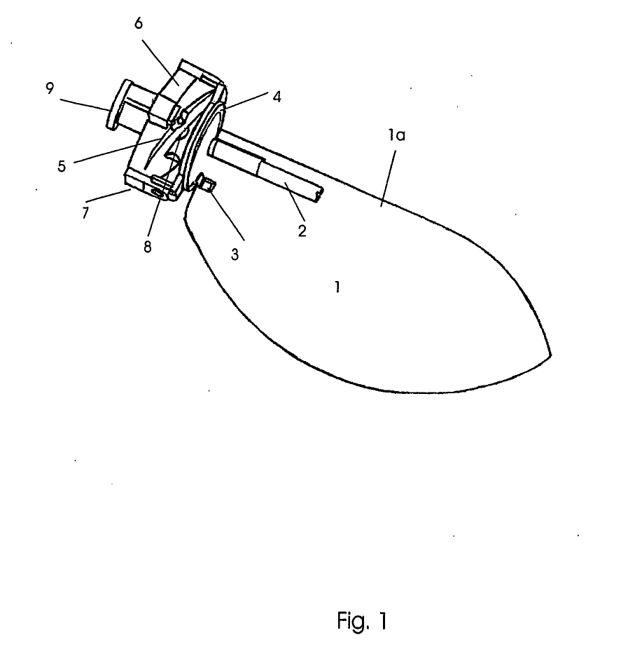

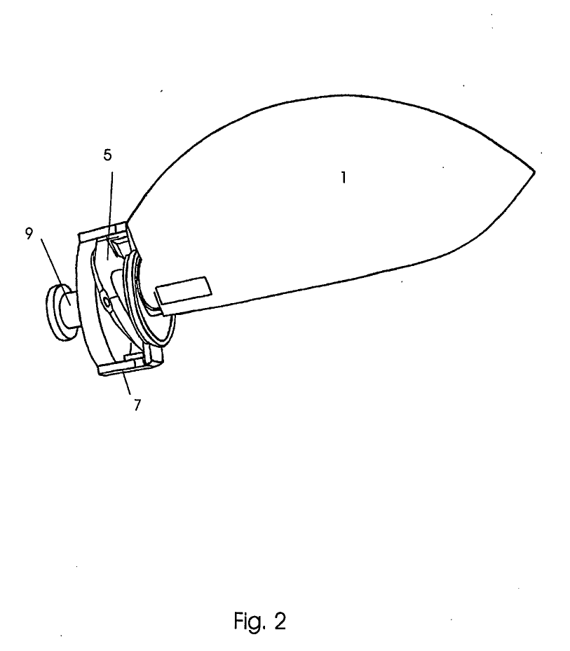

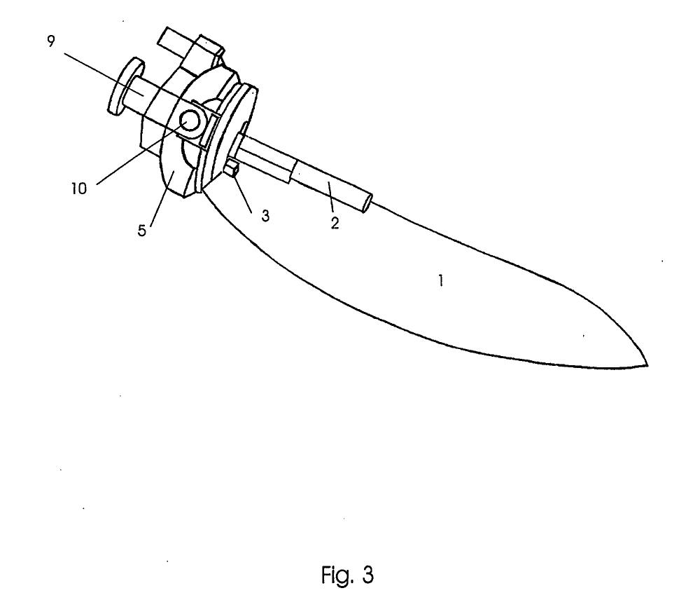

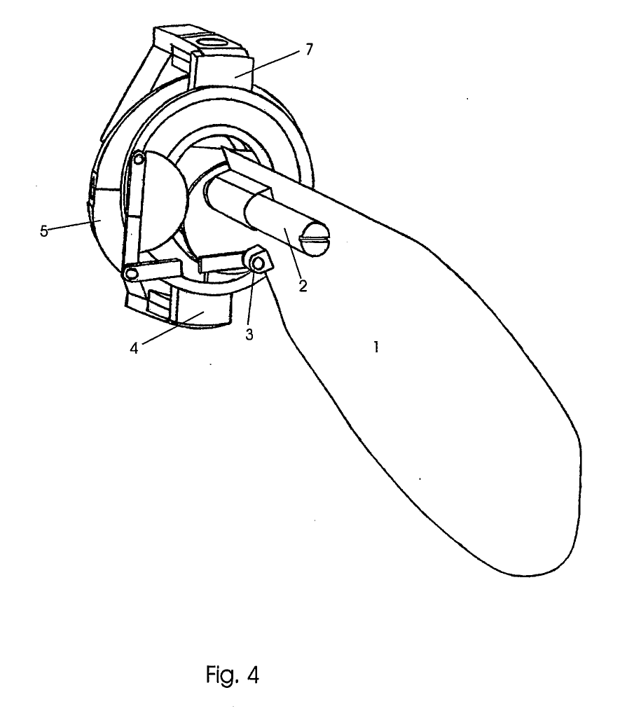

FIGS. 1 to 5 show views of a wing from different angles

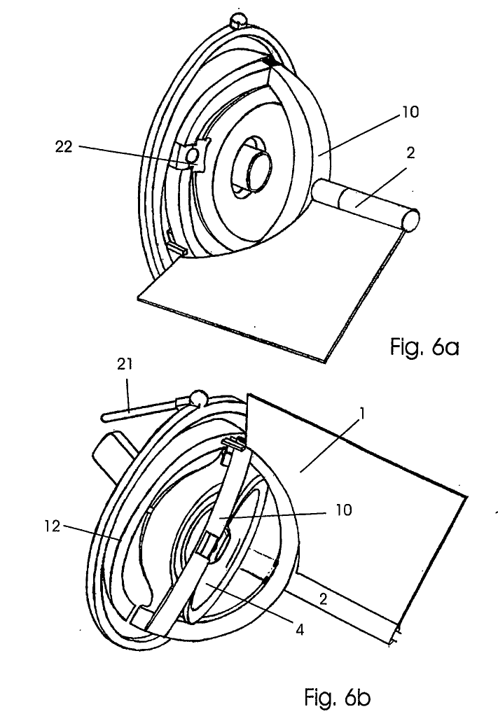

FIG. 6 shows a wing with the drive mechanism enclosed in a hub

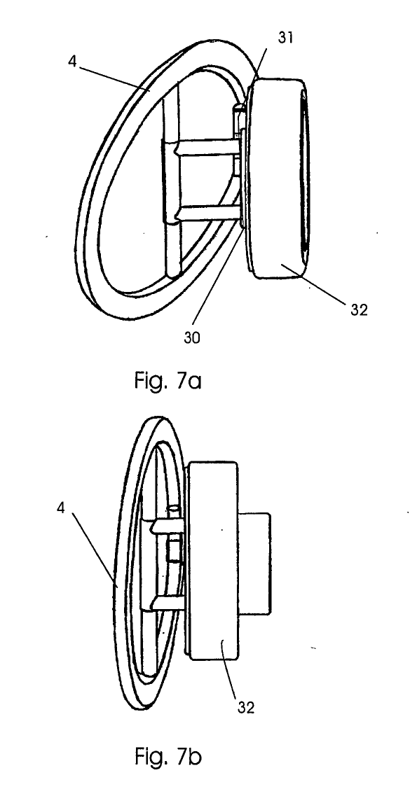

FIG. 7 shows a view of the cam arrangement

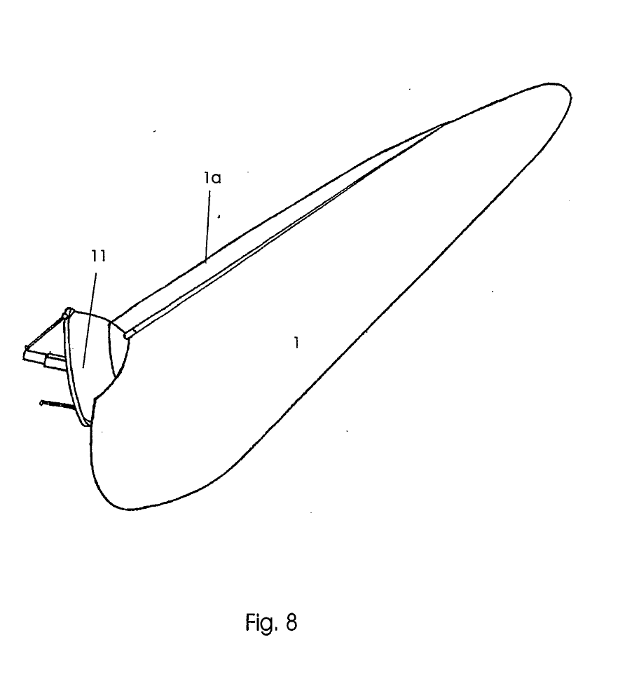

FIG. 8 shows the mechanism enclosed by a hub

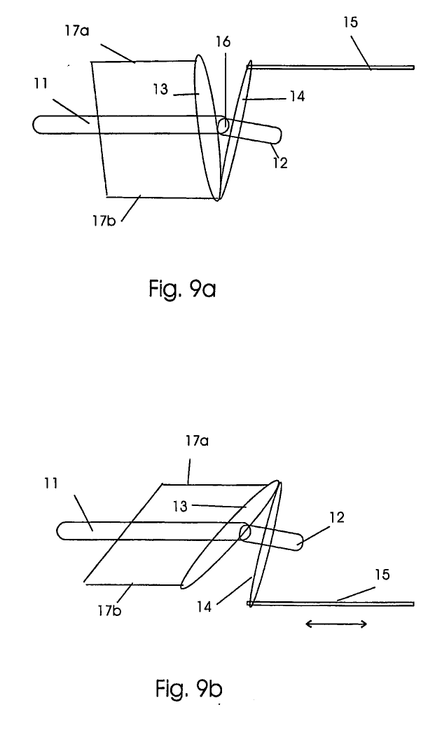

FIG. 9 shows schematically how a drive mechanism can operate

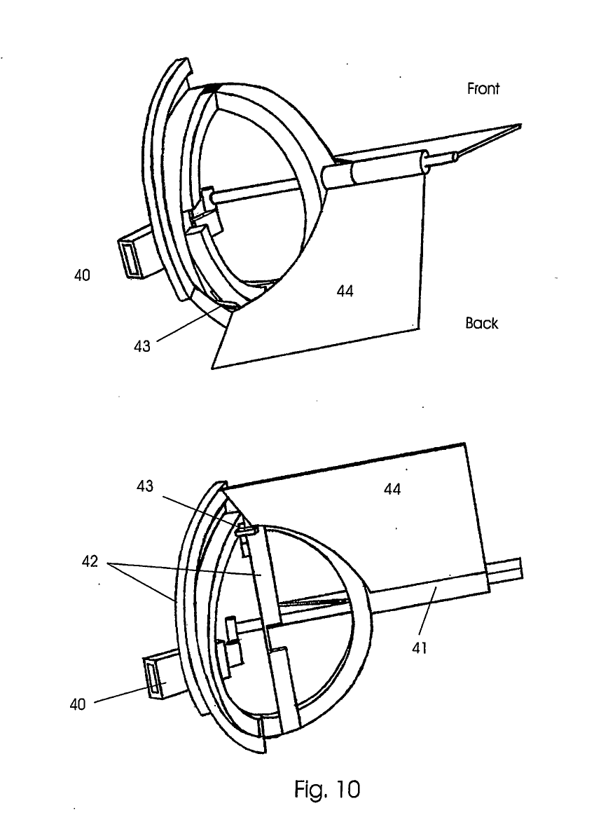

FIG. 10 shows the use of a linear motor

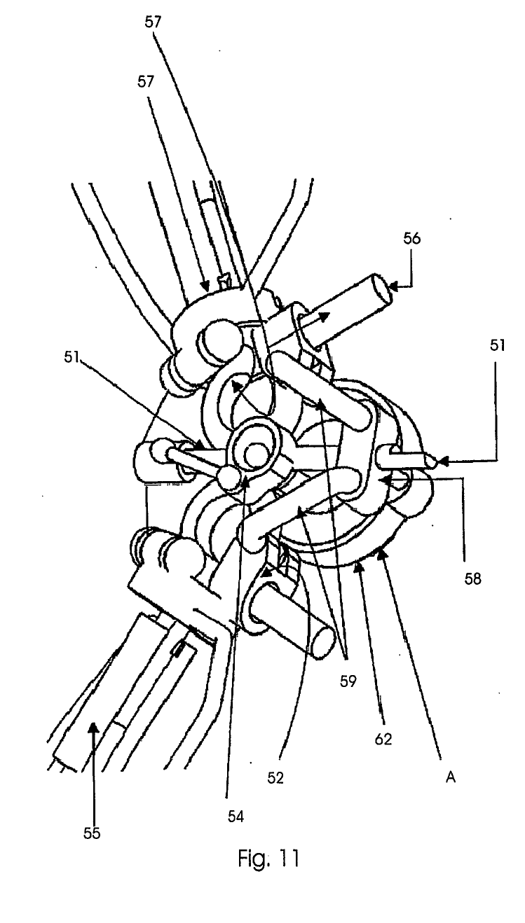

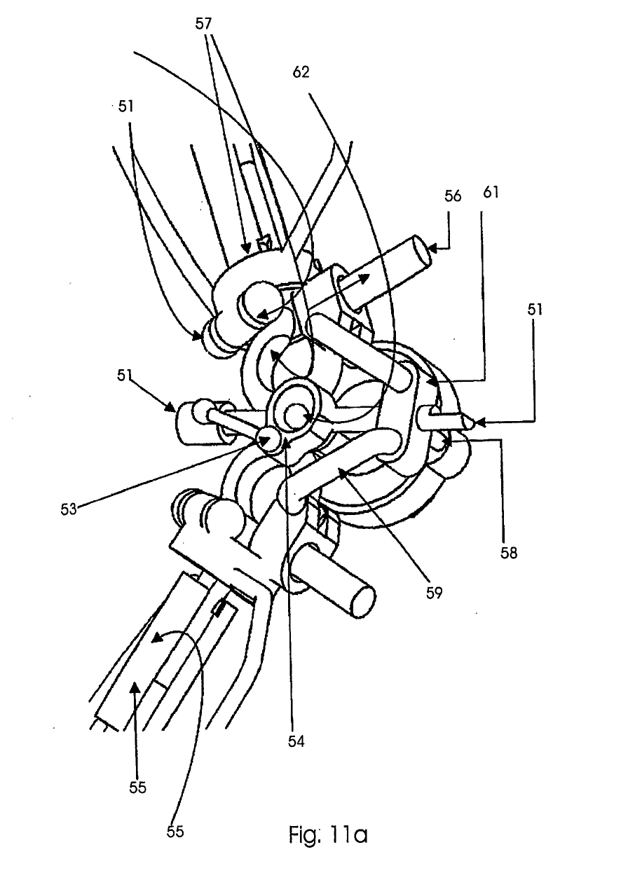

FIGS. 11 and 12 show details of a drive mechanism

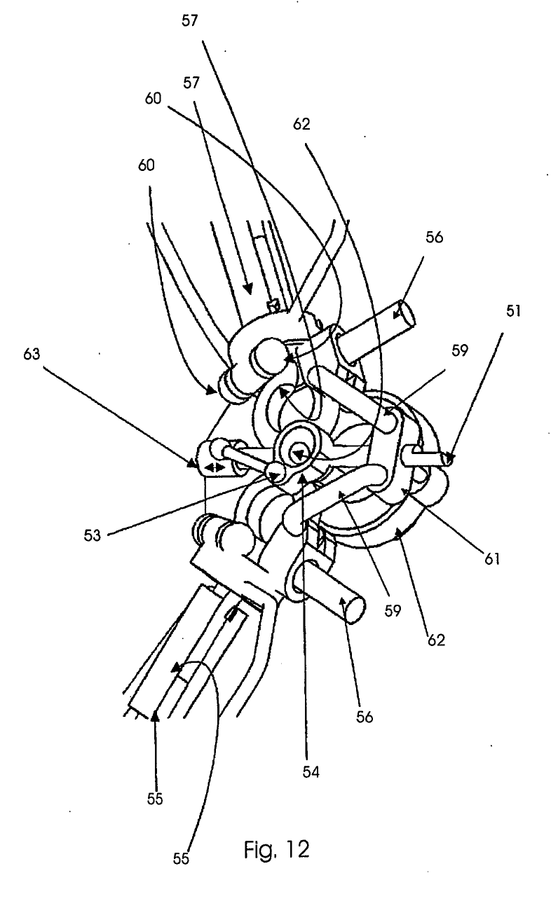

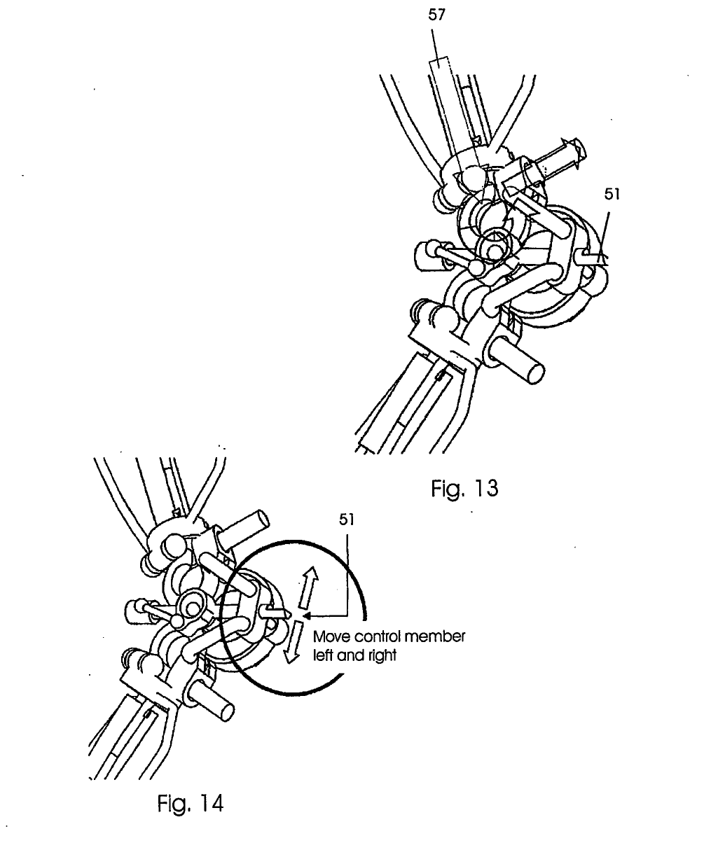

FIGS. 13 and 14 show details of a steering control mechanism

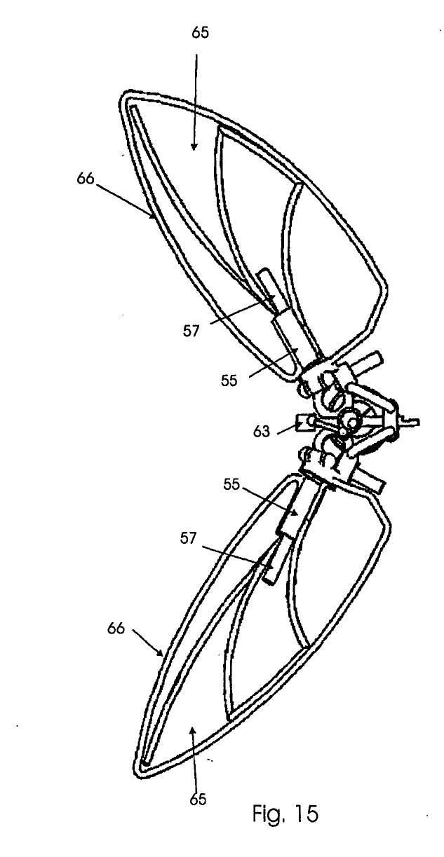

FIG. 15 shows an assembled wing

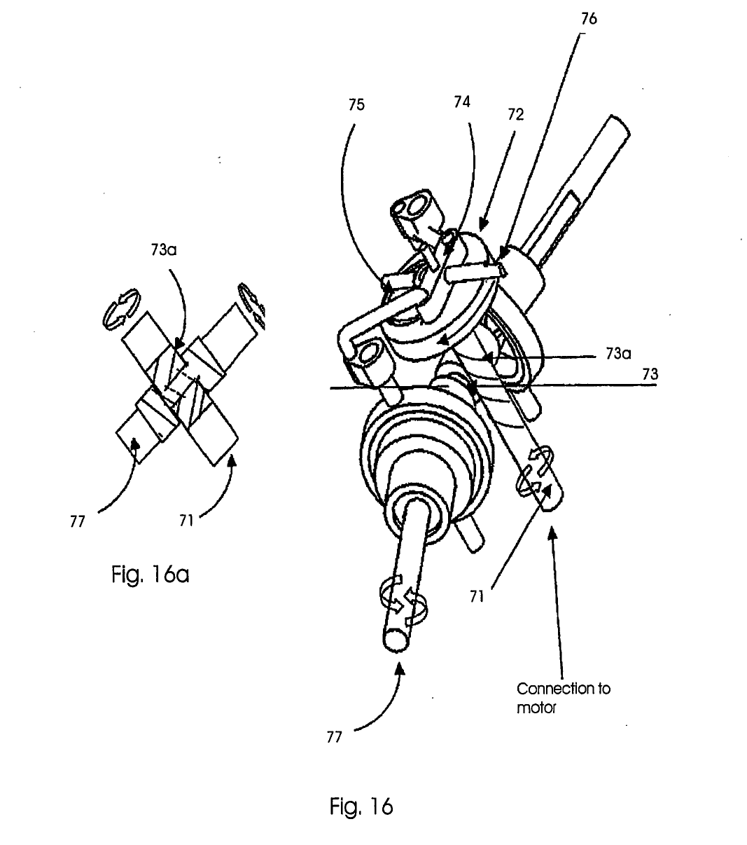

FIGS. 16 to 21 show a different embodiment of the invention in which there is a universal joint which links the two motions of the wing and

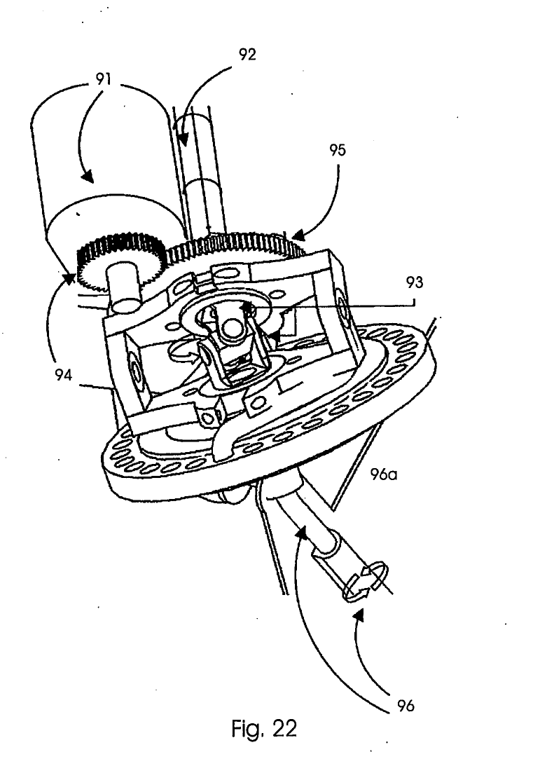

FIGS. 22 to 26 show a further embodiment of the invention.

Also included is a compact disc, the contents of which are included by reference, showing the moving operation of various embodiments of the invention described herein and which facilitates the understanding of the invention in a manner which is difficult to achieve from still drawings

Referring to FIGS. 1 to 4 of the drawings, a wing (1) made of a flexible semi rigid material is attached to a support strut (2). The strut (2) is attached to a cam (4) and the wing (1) is also attached to the cam at a second mounting point (3). The cam (4) is mounted on an axle and is attached to a ring (5) which is connected to a frame (7). The ring (5) is connected to the drive shaft (9) by frame (7) and there is a universal joint at (8) connecting (9) and (12).

In use the drive shaft (9) is rotated and the frame (7) rotates the ring (5) which rotates the cam (4). This causes the cam (4) to move relative to drive shaft (9) as shown by the arrows. As the cam (4) rotates and moves the strut (2) and mounting (3) cause the wing to move and flex with the mounting point (3) maintaining the leading edge of the wing (1a) substantially to the front.

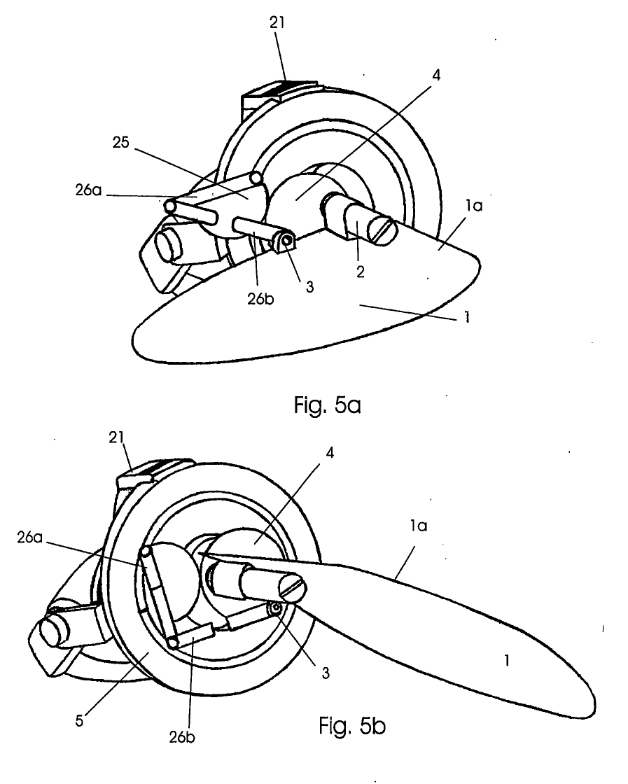

Referring to FIG. 5 an offset cam (4) rotates, the support member (2) moves from position of FIG. 5a to position of FIG. 5b, and drive member (25) rotates as shown so that wing mounting (3) is moved through arms (26a) and (26b) to cause wing (1) to flex as the wing mounting moves closer to support strut (2) by the action of cam (4).

Referring to FIG. 6 a small bus or buses (21) is mounted to a rail (12) via bearings, on the underside of the cam follower arm (20) and the side of the said portion of the back plate. The rail runs the full length around the cam follower member (21) and the said portion of the side of the back plate. The buses are free to move along the rail from end to end. The buses are then pivotally hinged where one edge of one bus joins the other edge of the opposite bus.

The trailing edge (22) of the back part of the wing is pivotally and slidably connected to the bus that is connected to the back of the cam follower member.

Referring to FIG. 7 the cam ring (4) is attached by telescopic drive plate to race bearing (32). There is an adjustable stabiliser (31) so that the cam angle can be adjusted while in motion.

Referring to FIG. 8, the hub (11) encloses the mechanism and which is connected to the wing (1) and front edge (1a) so as to enclose them.

Referring to FIG. 7 a drive shaft (11) has a frame (17a, 17b) attached to it so that the frame rotates with the shaft. The frame is attached to a ring (13) so the ring is rotated by the frame. There is an axle (12) attached to shaft (11) at universal joint (16) and the axle (12) has a drive member (14) mounted on it which is attached to ring (13) at point (18). There is a support strut (15) attached to the drive member (14) which is connected to a wing. The wing is attached to the drive member (14) at a second point (not shown).

In use the drive shaft (11) rotates and the cage (17) rotates ring (13) which causes axle (12) to rotate and thus move the support strut (15) and the wing.

This results in a complex movement of the wing which can cause the wing to generate lift.

Referring to FIG. 10 this shows two views of the use of a linear motor as the drive mechanism. In this embodiment, the linear motor (40) drives the front wing axle (41) which moves the wing. The bus (43) moves along bus rail (42) and causes the wing to move to and fro and flex.

FIGS. 11 to 15 show one embodiment of the invention and FIGS. 16 to 21 show a second embodiment of the invention.

Referring to FIGS. 11, 11a and 12 the mechanism consists of a guide rail (51) attached to a control member (52). There is a wing cam (54) which drives cam follower (53) and which rotates about central pivot point (64). The wing (65) is attached to wing sleeve (55) which is rotatably mounted on wing shaft (57); the wing shaft (57) is driven by wing shaft cam follower (58) which is driven by large cam (62).

In use, referring to FIGS. 11 and 12 the drive motor is attached to the main drive axle which is connected to the large cam (62) from the rear of the mechanism. The motor drives the main axle, the main axle runs through the centre of the mechanical wasp, through the large cam (62) located at the back of the mechanical wasp, and then through to the angular wing motion cam (54).

To produce the linear flapping motion of the wings, the large cam (62) to the rear of the mechanism in FIG. 11, is fixed to the main axle in an off centre position so that as the main axle rotates, the large cam (62) also rotates around the axle, but not about its own centre point. This means that the outer edge of the cam (62) moves in a circular motion larger than the cam itself. There is a rim which rides on the outer edge of the cam (62) and at the lowest point of this rim is a pin that connects the rim of the cam (62) to the wing shaft cam follower (58), located at the front of the mechanism positioned across the front of the large cam (62). As cam (62) rotates around the main axle in the offset position, their connection causes the wing shaft cam follower (58) to move up and down, guided by the guide rail (51).

Located at either side of the cam follower (58) are two push rods (59). Each push rod is connected a wing shaft socket (52). The wing shaft (57) is mounted to the wing shaft socket (52) via the wing stud (56) which is at right angles to the part of the wing shaft (57) on which the wing is mounted. As the wing shaft cam follower moves up and down, the push rods (59) cause the wing shaft sockets to move up and down in a semi-circular motion, resulting in the linear motion of the wings.

Referring to FIG. 12 to produce and control the angular rotation of the wing, the main drive axle which causes the large cam to rotate at the back of the mechanism also causes the angular wing motion cam (54) at the front of the mechanism to rotate. The angular wing motion cam (54) has a wing angle cam follower (53) connected by a ball and socket joint to a front surface of the component. The other end of the wing angle cam follower (53) is connected to the wing angle guide (63). In motion the angular wing motion cam (54) rotates leading the bottom end of wing cam follower (53) around with it, because it is also connected to the wing angle guide (63). The rotating motion of the angular wing motion cam (54) imparts a repetitive upwards and downwards motion to the wing angle guide (63); this movement is controlled by the guide rail/control member (51).

The wing angle guide (63) is in turn connected to two ball and sockets joints (60) by means of a bar. The ball and sockets joints (60) are connected to bearings at the base of the wing sleeve (55). As the wing angle guide (63) moves up and down the ball and socket joints (60) which are connected to the bearings pull the wing sleeve (55) back and forwards in a rotating motion around wing shaft (57), which changes the angle of attack of the wing in a controllable manner as they flap up and down.

Referring to FIGS. 13 and 14, moving the control member (51) to the left and right, will cause the wings to lower and raise. If the left wing dips the mechanism flies left and if the right hand wing dips the mechanism flies right.

Referring to FIG. 15 the wing comprises a flexible membrane (65) stretched over a lightweight frame (66) connected to the mechanism by wing sleeve (55) and wing shaft (57) so the wing flexes as the mechanism operates to generate both lift and forward motion. By adjusting the controls the device can be made to hover or move in any direction.

Referring to FIGS. 16 and 16a where FIG. 16 a shows a part of FIG. 1; in this embodiment there is a universal joint which links the two motions of the wing.

In the mechanism there is a main drive axle (71) connected to a motor which is the essential power source, generating a powerful circular motion through the main drive axle (71).

To produce rotation of the wing shaft (77) there is located halfway along the main drive axle (71) the universal joint (73). The universal joint has two worm wheel gears (73a) (FIG. 16a) that sit either side of the main drive axle (71) as shown with arrows. In motion the main drive axle (71) is powered by the motor producing clockwise rotation, this causes the universal joint (73) to rotate through the worm wheel gears (73a) creating a simultaneous similar motion in the wing shaft (77) shown in FIG. 16. The motor powers the main drive axle (71) in a clockwise rotation and the universal joint causes the wing shaft to rotate in an identical manner.

To produce the linear flapping motion of the wings, further along the main drive axle (71) is fixed to the cam (72), which is positioned at the front of the mechanism. The motor generates motion in the main drive axle (71) creating circular motion through the centre of the mechanism to the cam (72) causing cam (72) to also rotate in a clockwise direction. There is a circle set in to the front surface of the cam (72) located off centre, this is the cam groove (75). The cam groove (75) maintains an off centre position as the cam (72) rotates with the main drive axle (71).

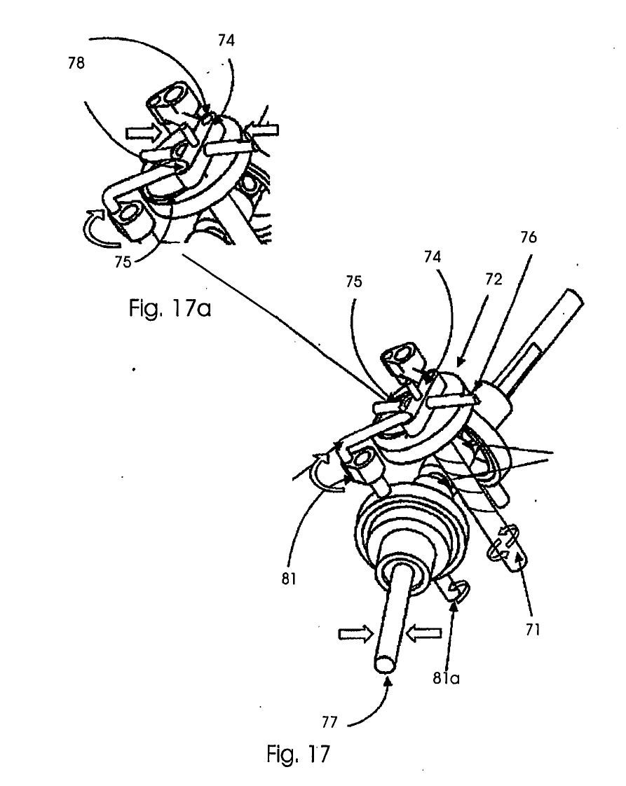

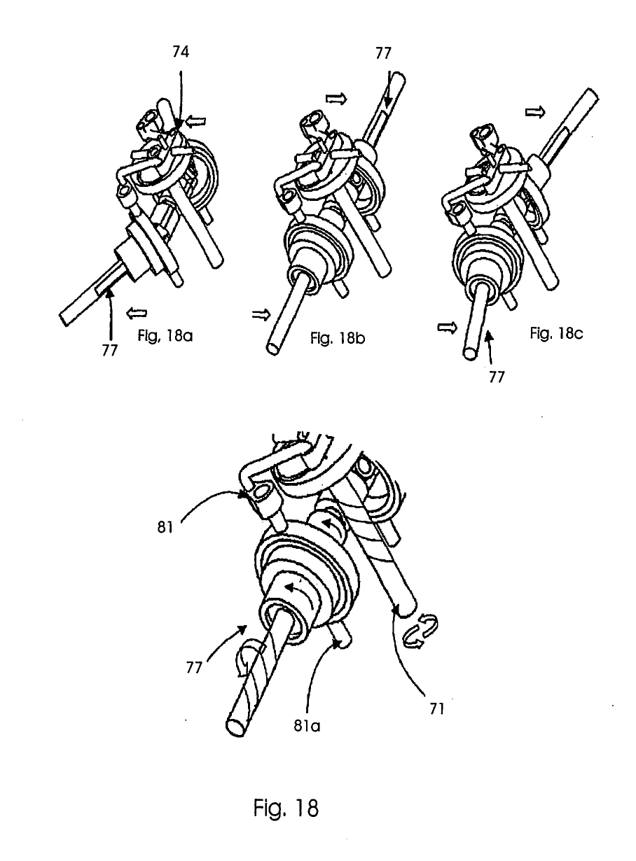

Referring to FIGS. 17, 17a and 18, where FIG. 17a shows part of FIG. 17; located at the front of the mechanism positioned across the front of the cam (72) is a cam follower (74). This component can move up and down along the control member which runs through it; it also has a pin positioned in the centre which travels through the cam follower (74) and sits in the cam groove (75). In motion the main drive axle (71) is rotating causing the cam (72) to rotate, because the cam follower pin is sitting in the cam groove (75); this causes the cam follower (74) to move up and down along the control member (76) as the cam (72) rotates. The cam follower (74) when in motion moves up and down following the cam groove (75).

Located at either end of cam follower (74) are two push rods (78). Each push rod (78) is connected at a pivot point (81). The pivot points (81) rotate the pivot rods (81a) through a set angle as the push rods (78) move up and down. The pivot rods (81a) are fixed to the wing shafts (77) at right angles. In motion the cam follower (74) moves up and down causing the push rods (78) to rotate the pivot points (81) which by rotating the pivot points causes the up and down motion of the wing shafts (77) via the pivot rods (81a). This movement is more clearly illustrated in FIGS. 18 to 18c.

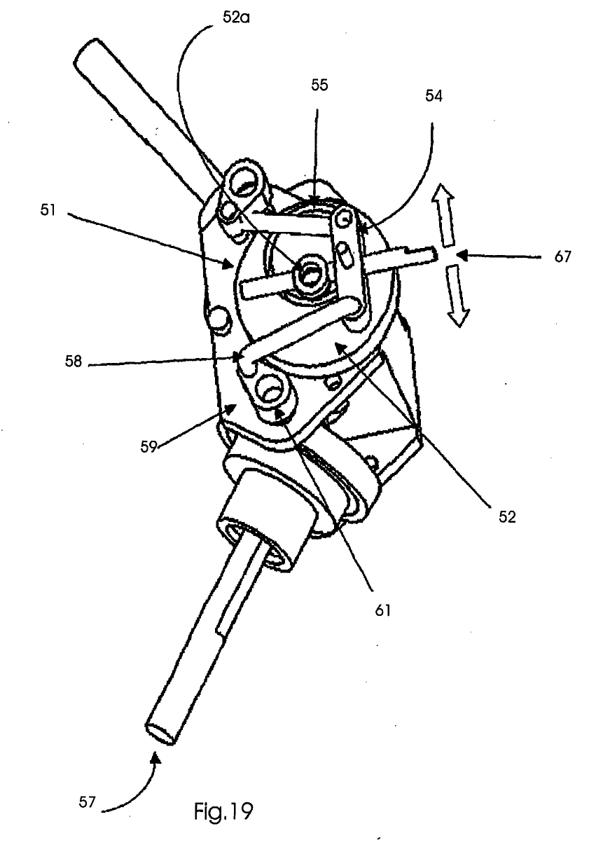

Referring to FIGS. 19 and 19a, to change the direction of flight of the mechanism is the control member (87). The control member is fixed to the mechanism through the central pivot point of the cam (72a) so that as the cam (72) rotates, the control member maintains its upright position with the cam follower (74) moving up and down. The bottom end of the control member (87) can be moved to the left or the right independently of the cam (72) but while still being fixed at the central pivot point of the cam (72a). When the control member (87) is pushed to the left, the path of the cam follower, which moves along it, is shifted to the left. This changes the positions of the push rods and the range of motion of the pivot points, which cause the up and down motion of the wing shafts. This means that the movement of the wing shafts on each side of the mechanism is no longer symmetrical which causes a change in the direction of flight, by banking to the left or to the right.

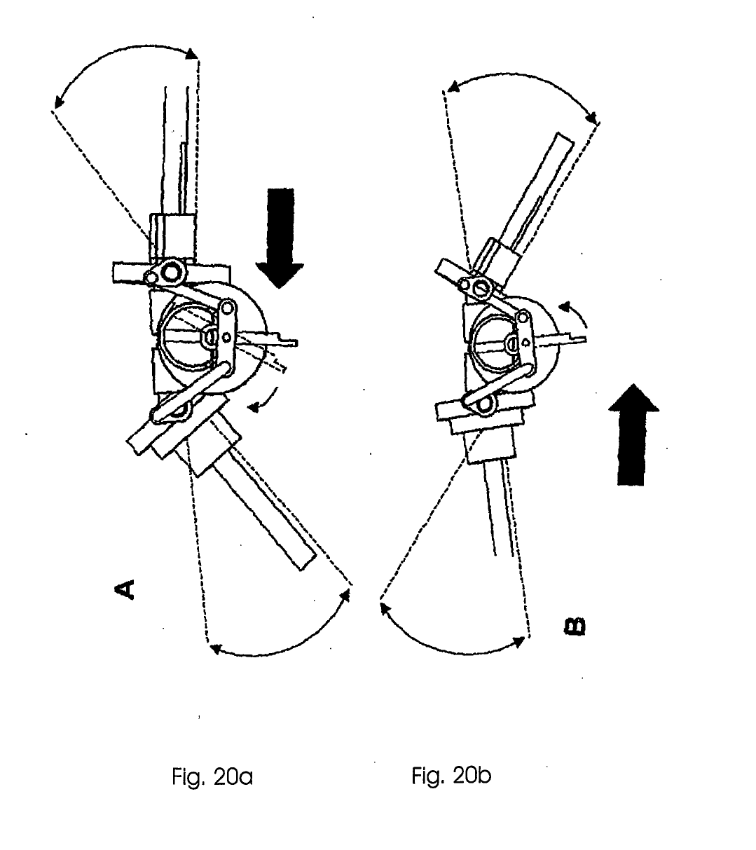

The changing wing movement caused by moving the control member to the left or right is more clearly illustrated in FIG. 20. If the control rod is moved so one wing dips and the other is raised (A) the wings turn as in a banked turn. If the control rod is moved so the wings move about a vertical axis (B) they will turn in a flat turn. In practice these two operations can be combined.

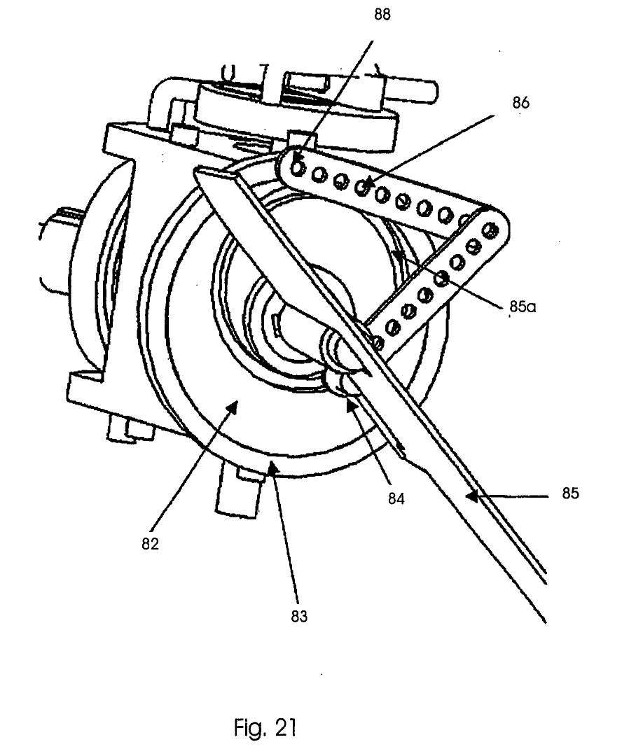

Referring to FIG. 21; at the base of the wing shaft in a fixed position is the angular drive cam (82). It is fixed so that it rotates with the wing shaft. On the face of the angular drive cam (82) is an off set circular groove, the cam groove (85a). Around the outer edge of the angular drive cam (82) sits a directional control ring (83). The directional control ring (83) is static, while the angular drive cam (82) rotates with the wing shaft.

To produce and control the angular motion of the wing, the mechanical wasp wing is controlled via a hinged arm (88), which is fixed to the outer directional control ring (83) at one point, maintaining a static position. The other end of the arm is connected to the wing (84). Part way along the arm (88) there is a cam follower pin (86) which sits in the cam groove (85a) so, as the angular drive cam (82) rotates, the pin follows the cam groove (85a) causing the hinged arm to open and close. The hinged arm is connected to the wing (85) so that when the hinged arm is opened and closed the angular direction of the wing is changed.

Referring to FIG. 22 the motor (91) drives small cog wheel (94) which drives large cog wheel (95) which turns the main drive axle (92) which turns bent wing shaft (96) via universal joint (93).

In use the mechanical wasp is powered by the motor (91) placed in the lower half of the mechanism central to the structure. When in motion the motor powers the small cog gear (94); this causes the small cog gear (94) to move in a clockwise rotation.

Positioned alongside the small cog gear (94) is a large cog gear (95). In motion the small cog gear (94) rotates in a clockwise manner causing the large cog gear (95) to move in a counter clockwise rotation.

Running through the centre of the large cog gear (95) and fixed to it is the main drive axle (92) so that as the large cog rotates it causes the main drive axle to rotate.

The main drive axle (92) is connected to the bent wing shaft (96) via a universal joint (93). The universal joint (93) is made up of two joints, which are linked from two different directions. This allows the motion from the main drive axle (92) to travel via the universal joint (93) through to the bent wing shaft (96) causing this to also rotate; in turn the wing (96a) swoops in an angular motion.

The use of a universal joint (93) allows the angle of the bent wing shaft (96) in relation to the main drive axle (92) to be adjusted whilst still maintaining a rotational movement through both the main drive axle (92) and the bent wing shaft (96).

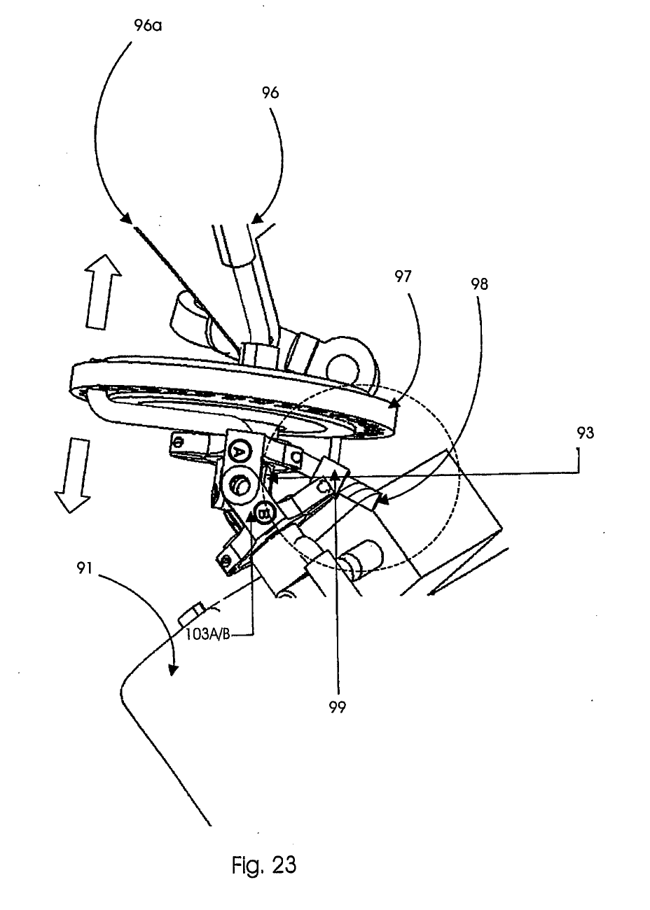

The angle of the bent wing shaft (96) in relation of the main drive axle (92) is adjusted as shown in FIG. 23.

Referring to FIG. 23 the cam (97) is connected to the defected rod (98) and held by retainer (99). The angle of the cam (97) and the bent wing shaft (96) in relation to the main drive axle (92) can be adjusted by turning the defected angle of defected rod (98). The defected rod (98) is connected at its base to the adjustable wing mount (103A) and runs through a retainer (99) which is connected to the wing mount (103B). When the defected rod (98) is adjusted downwards by turning in a clockwise motion the angle of the cam (97) and the bent wing shaft (96) are changed via the universal joint (93). This applies to turning the defected rod in a counterclockwise motion.

This adjustment affects the angle of rotation in the bent wing shaft (96).

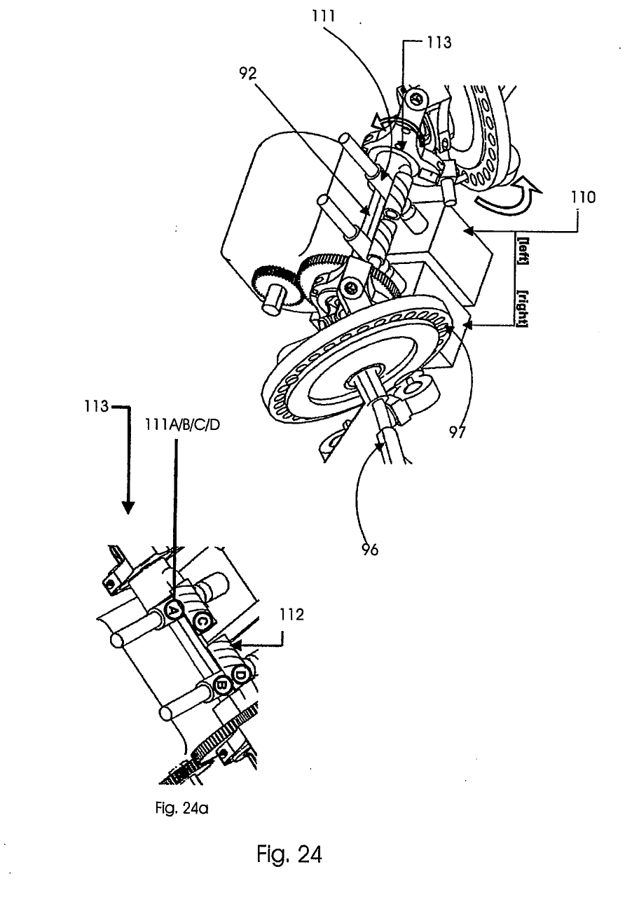

FIGS. 24 and 24a show the adjustment of the angle of flight by rotating alternate wings via the control servos. In this figure there are control servos (110) which are shown by the two cubes positioned at the back of the mechanism.

The control servos (110) have two rods protruding from a central position. There is one worm wheel gear fixed to each rod (111A/B). Positioned at right angles above these worm wheel gears (111A&B) are two more (111 C&D). These are fixed to the adjustable wing mount brackets (113).

In motion the control servos left or right are activated, creating a rotation in the two worm wheels (111A&B) causing the two upper worm wheel gears (111C&D) to rotate via the inter locking wheel gear teeth (112).

The worm wheel gears (111C&D) cause the fixed adjustable wing mount brackets (113) to rotate by a few degrees, causing the cam (97) to rotate and in turn the angle of the bent wing shaft (96) is changed.

Activating the servos affects-alternative wings, creating a different angle of flight in the mechanism.

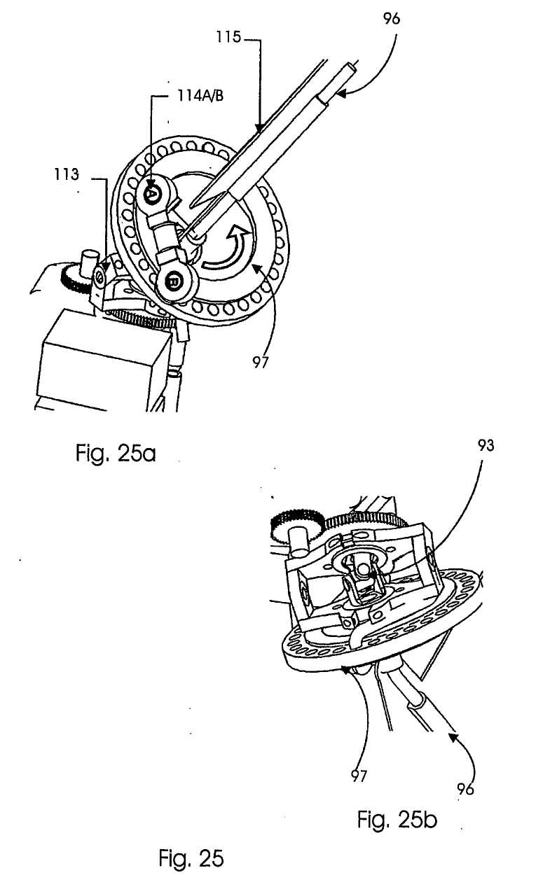

Referring to FIGS. 25 and 25a these illustrate how the rotating motion of an off set cam creates an orbital flight pattern. The off set cam (97) is mounted on the wing shaft, which is connected to the main drive axle (92) via the universal joint (93). In motion the main drive axle (92) rotates causing the universal joint (93) to rotate, in turn creating a rotation of the bent wing shaft (96) and the off set cam (97).

The wing sleeve (115) has a ball joint (114A) connected to the lower section. The other end of the ball joint (114B) is connected to the outer rim of the off set cam (97). This means when the off set cam (97) rotates, this causes the fixed ball joints (14A/B) to guide the wing sleeve round in a gliding orbital motion, independently of the bent wing shaft (96).

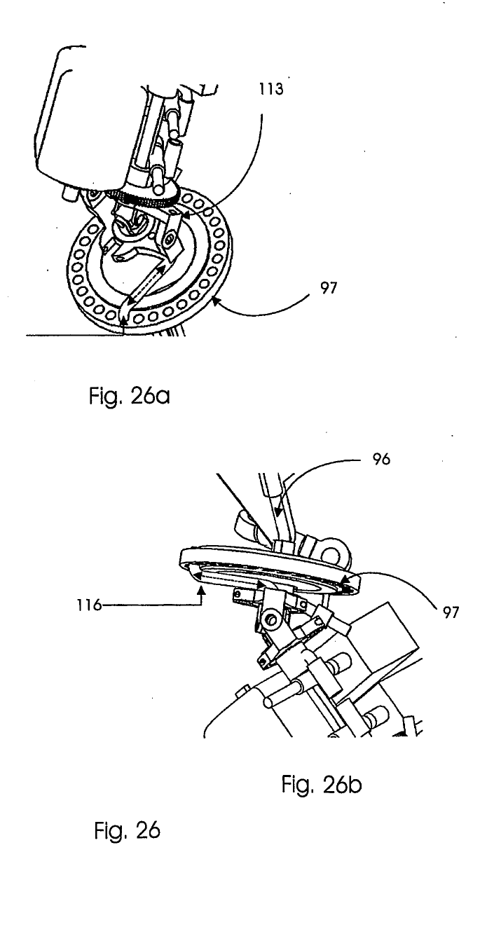

FIGS. 26 and 26a illustrate the adjustment of the amount of angular motion via a rod. In these the angular motion adjustment rod (116) is connected to the adjustable wing mount brackets (113) at one end and the other end is connected to the off set cam (97) acting as an anchor limiting or increasing the angular motion. If the angular motion adjustment rod (116) is shortened this will decrease the angular motion of the off set cam (97) in turn creating a smaller orbital motion in the wing shaft.

If the angular motion adjustment rod (116) is lengthened this will increase the angular motion of the off set cam (97) in turn creating a larger orbital motion in the wing shaft.

1-28. (canceled)

29. An apparatus for assisting in flying which comprises a flexible wing and a drive in which the wing is connected to the drive by a drive mechanism which oscillates or rotates the wing simultaneously about an axis and the axis is moved linearly back and forth and the combination of these two movements gives a flexing of the wing to produce lift.

30. An apparatus as claimed in claim 29 in which the drive is rotational or linear.

31. An apparatus as claimed in claim 29 in which the drive mechanism comprises
(i) a support member attached to the flexible wing at a first mounting point on the wing
(ii) a drive means able to impart a linear oscillation to the support member
(iii) a second mounting point on the wing attached to the drive means spaced apart from the support member whereby when the drive mechanism operates the support member moves linearly and the wing flexes due to the relative motion of the support and the second mounting point to produce angular wing movement.

32. An apparatus as claimed in claim 31 in which the drive member comprises a rotatable offset cam mounted on a back plate at an angle to the back plate with the support member attached to a cam follower and the second mounting point attached to the back plate.

33. An apparatus as claimed in claim 32 in which the cam angle is adjustable.

34. An apparatus as claimed in claim 29 in which the drive mechanism incorporates a drive shaft connected to the axle of a drive member through a universal joint, the drive shaft and the axle of the drive member being at an angle to each other and there being a rotor connecting member mounted on the drive shaft which is connected to the drive member at one location.

35. An apparatus as claimed in claim 31 in which the first mounting point is adjacent to the leading edge of the wing and the second mounting point is nearer the trailing edge of the wing and, in use the drive mechanism is configured so that, as the rotor rotates, the leading edge of the wing stays substantially at the front of the wing.

36. An apparatus as claimed in claim 29 in which the wing is articulated.

37. An apparatus as claimed in claim 36 in which the leading edge of the wing articulates separately from the rest of the wing.

38. An apparatus as claimed in claim 36 in which the wing articulates in three sections.

39. An apparatus as claimed in claim 31 in which the support means is a rod or strut which is pivotally attached to the wing.

40. An apparatus as claimed in claim 31 in which the wing at the first mounting point is attached to a wing shaft and the back part of the wing is also pivotally mounted along its length to the wing shaft via a connector and the trailing edge of the back part of the wing pivots up to 20 degrees (relative to the front part of the wing) around the wing shaft, and back again, while the wing shaft oscillates backwards and forwards on each full wing stroke.

41. An apparatus as claimed in claim 36 in which an articulating member is connected to the trailing edge of the back part of the wing, parallel to the wing shaft and a second member is pivotally connected to the free end of the first member and then connected to the back plate there being a circular offset cam mounted to the main drive shaft and a half round (amplifier) cam mounted to the member connected to the back plate, facing inwards and rotatably fixed to the offset cam.

42. An apparatus as claimed in claim 41 in which, as the offset cam rotates, it causes the middle part of the cam follower member to rise and fall relative to the back plate and when the gap is opened to its widest point, the middle has a much larger gap than where the ends meet, the gap closing in a scissor like manner from corner to middle with the back end of the cam follower member and the edge of the side of the back plate as twin guide rails there being a small bus mounted to a rail via bearings, on the underside of the cam follower arm, and the side of the said portion of the back plate, the rail running the full length around the cam follower member and the said portion of the side of the back plate with the buses being free to move along the rail from end to end and are then pivotally hinged where one edge of one bus joins the other edge of the opposite bus.

43. An apparatus as claimed in claim 31 in which the support member is a rod or strut which is pivotally attached along the wing.

44. An apparatus as claimed in claim 29 in which the drive mechanism is arranged such that the drive member follows a linear or generally rotary, preferably circular cyclic motion.

45. An apparatus as claimed in claim 29 in which the wing comprises a lightweight plastics or metal material which is secured to a frame.

46. An apparatus as claimed in claim 29 in which the drive comprises a linear motor.

47. An apparatus as claimed in claim 29 in which, by tuning the amplitude and the frequency of the oscillating and linear movements the wing can be made to move so that only positive lift is generated and substantially no negative lift is generated at any stage.

48. An apparatus as claimed in claim 46 in which the wing is attached to a sleeve or collar mounted on an axle so that the oscillating motion is imparted by movement of the sleeve over the axle and the axle is moved linearly to generate the linear motion.

49. A flying device which incorporates at least two of the apparatus as claimed in claim 29 together with a motor which powers the drive.

50. An apparatus as claimed in claim 47 in which there is a common drive shaft which operates both the oscillating and the linear movements.

51. An apparatus as claimed in claim 47 in which there are at least two wings driven by the same power source so that they flap together or in sequence.

52. An apparatus as claimed in claim 51 in which there are means to control the direction of flight by dipping one wing and raising the other.

53. An apparatus as claimed in claim 48 in which there are means to control the direction of flight by moving the wings sideways.

54. An apparatus as claimed in claim 51 in which the means to control the direction of flight by moving the wings comprises a control rod connected to the wings which control rod can be twisted and/or moved from side to side and/or back and forth.

55. An apparatus as claimed in claim 29 adapted for manipulating a multi articulating leg mechanism capable of emulating an insect walking gate in which the support member is attached to a first part of the leg mechanism and the second mounting point attached to a second part of the articulating leg so that a walking motion is imparted to the leg.

56. An apparatus as claimed in claim 29 adapted for operating underwater.

57. An apparatus as claimed in claim 47 in which the wing is attached to a sleeve or collar mounted on an axle so that the oscillating motion is imparted by movement of the sleeve over the axle and the axle is moved linearly to generate the linear motion.

58. An apparatus as claimed in claim 53 in which the means to control the direction of flight by moving the wings comprises a control rod connected to the wings which control rod can be twisted and/or moved from side to side and/or back and forth.
